(19) United States
(12) Patent Application Publication
(10) Pub. No.: US 2012/0330580 A1
(43) Pub. Date: Dec. 27, 2012

(54) SYSTEM AND METHOD FOR DETERMINING A BEARING STATE

(75) Inventors: Thomas Fruh, Oberasbach-Rehdorf (DE); Jörg Hassel, Erlangen (DE); Carsten Probol, Buckenhof (DE); Hans Tischmacher, Lauf (DE)

(73) Assignee: SIEMENS AKTIENGESELLSCHAFT, München (DE)

(21) Appl. No.: 13/580,862

(22) PCT Filed: Feb. 3, 2011
(86) PCT No.: PCT/EP2011/051520

§ 371 Date: Aug. 23, 2012

(30) Foreign Application Priority Data
Feb. 24, 2010 (DE) 10 2010 002 294.2

(51) Int. Cl. G06F 19/00

(52) U.S. Cl. 702/57

(57) ABSTRACT

In a system for ascertaining a bearing state and in a method for ascertaining a bearing state of a bearing of an electric machine, measurement value (21) is ascertained by means of a sensor unit (20). The measurement value is transmitted to a simulation unit (22), wherein a result value (23) is ascertained by means of the simulation unit (22), wherein the result value is in particular a bearing-current value or a value that is dependent on the bearing current. The result value (23) can be transmitted to a further unit (24).

The invention relates to a method and a device/system for simulating an electrical loading on a bearing, for a bearing in an electric machine.

In the bearings of electric machines, such as for example an electric generator or an electric motor, unwanted current flows can arise as a consequence of the build-up of an electrostatic charge or when powered by a power electronic actuator. Some of these bearing currents are so-called EDM (electric discharge machining) currents, whereby electric arc discharges occur in the bearing. Flashovers and discharges arise, in particular, in the lubricating film located between the rolling elements and the raceways of the bearing concerned. This can initiate premature deterioration of the lubricant and of the entire bearing. Premature failure of the bearing is also a possible consequence.

It is one object of the present invention to specify method and a device for simulating a bearing current or an electric loading on a bearing, as applicable.

One solution to this object is given, for example, by a method or system, as applicable, in accordance with one of the claims 1 to 12.

In electric machines, bearing currents can time and again lead to problems. In the case of mains-powered motors, bearing currents arise which result, for example, from:

asymmetries in the magnetic circuit,

manufacturing tolerances, and/or

material anisotropies.

They make an appearance, with disadvantages, above all in the case of large machines on a sinusoidal power network.

An asymmetric distribution of the magnetic flux in the motor induces a voltage in the shaft, the effect of which is that a low-frequency current flows through the bearing. These bearing currents circulate in a closed circuit: shaft-bearing-bearing end-plate-housing.

One remedy is achieved, for example, by interrupting the current flow. The insulation of a bearing, expediently on the operating side, can result in the problem being solved.

Over and above this, bearing currents also arise because the supply is from a converter. The basis of this is, for example, converters with an intermediate voltage circuit. With converter-powered motors, parasitic effects arise, which can manifest themselves by a current flow through the motor bearing. Electric arc discharges through the lubricating film of the bearing can lead to melting of the material in the bearing races. In extreme cases, these changes can lead to a total failure of the bearing assembly.

In the case of three-phase drives with a power-electronics supply, grounding brushes can be used between the rotor and the housing for the purpose of avoiding a damaging bearing current. This achieves grounding of the rotor. However, grounding brushes are subject to wear, so that the maintenance and servicing effort increases. In addition, the reliability of contacting by the grounding brushes is not always ensured, especially in difficult environmental conditions, so that even then bearing currents can develop and an increase in bearing wear occur. For the purpose of avoiding a bearing current, various other remedial measures are also possible such as for example, for the avoidance or minimization of bearing damage, hardware remedies (other cables, better grounding, potential equalization in the system, grounding brushes, common-mode filters).

In order to extend the service life of a bearing, other measures can also be taken. For example, an electric voltage which is present in the electric machine can be measured, whereby a common-mode voltage is determined from the result of the measured voltage, where a compensation voltage is determined on the basis of the common-mode voltage and a component of the electric machine which is electrically connected to the bearing has the compensation voltage applied to it, so that a drop in the bearing voltage across the bearing is at least partially compensated.

The bearing currents can then be suppressed for a specific operating point and system, that is in particular taking into account the conditions. The application to the bearing of the compensation voltage determined, in particular, on the basis of sensing the state leads to a broad compensation of the bearing voltages which otherwise, if their values were too large, would produce electric arc discharges and with them the bearing currents. The remaining residual bearing voltages are too low to still produce electric arc discharges of a damaging size. In the ideal case, the measured bearing voltages disappear completely as a result of the compensation.

It is also possible to sense the bearing voltage which arises across the bearing, or the bearing current flowing through the bearing, and to take them into account also in determining the compensation voltage. This enables the quality of the compensation to be further improved.

Unlike the common-mode voltage, which represents an indirect measurement variable, the bearing current and the bearing voltage are direct measurement variables which permit direct monitoring of the conditions in the bearing concerned. The sensing, and in particular the feedback, of these direct measurement variables, permits a very rapid reaction to state changes in the bearing.

In the assessment and/or compensation of bearing currents, it is important that the state of the bearing concerned is known. It is possible to attempt to specify the electrical state of the motor bearing by measuring the ground leakage currents, shaft currents and shaft voltages. In this way, it is possible to deduce indirectly the current flow in the bearing.

By the use of external measured values (e.g. ground leakage currents, terminal voltage, shaft current, shaft voltage (bearing voltage), bearing temperature, vibration, rotational speed, indirect bearing currents through bypassed insulation, rate of voltage change, pulse frequency, etc.) it is possible to calculate, on the basis of a simulation model, internal measurement variables (size of the bearing lubrication gap, bearing capacitance, bearing currents etc.). It is further possible, by a combination of internal and external values, to calculate so-called process characteristic values, such as for example:

frequencies of bearing current peaks;

frequencies of voltage peaks;

frequencies of voltage change rates;

determination of the relationship of a present frequency to that at the time of system startup;

splitting up into frequency classes and calculation of the rise over a time deltaT;

calculation of the energy transmitted through the bearing lubrication gap as the product of the measured bearing voltage and the calculated bearing current by integration over time; and/or

a bearing state.

It is similarly possible to estimate the energy or the power density transmitted through the bearing lubrication gap. This enables the bearing's service life to be estimated.

In one method for determining the state of a bearing, for a bearing in an electric machine, a measured value is determined using a sensor unit. This sensor unit is, for example:

a current sensor;

a voltage sensor;

a Hall sensor;

the total of all the sensors or a plurality of sensors which are affixed on and around the motor's bearing assembly (temperature probes, vibration sensors, brushes for measuring the bearing voltage, etc.);

a voltage meter in the motor terminal box;

a current converter around the grounding and power lines or the shaft; and/or

suchlike.

The measured value is, for example, an analog measured value or a digital measured value of a current or a voltage.

The measured value, or even a plurality of measured values, is communicated to a simulation unit. The simulation unit can be, for example, the converter (in the case of calculated values), or a sensor management unit (e.g. a condition monitoring system, SIPLUS CMS), a processor located on a motor, etc. A result value can be determined by means of the simulation unit. The result value is, for example, a bearing current value or a value which depends on the bearing current. The result value can be communicated to a further unit. The result value can also be, for example, a graphic representation, an alarm message, a warning message and/or a traffic-light type of representation of the values already mentioned above, such as the bearing lubricating gap size, bearing capacitance, bearing current, frequency of bearing current peaks, frequency of voltage peaks, etc.

The further unit is, for example, an evaluation unit, where the evaluation unit processes the result value in such a way that a bearing state value is determined. The evaluation unit can be, for example, a hardware unit and/or a software unit. Equally, the simulation unit can be a hardware unit and/or a software unit.

The simulation unit and the evaluation unit can, for example, be realized in the same hardware unit, so that the simulation and the evaluation are carried out, for example, on the same processor unit.

It is, for example, also possible that the result values and/or the bearing state values are calculated on an integrated process computer. For this purpose, the integrated process computer has a simulation model by means of which the variables are calculated. The integrated process computer is, for example, a programmable logic controller (PLC), a computer numerical control (CNC), an adjustable converter or the like. It is also possible to implement a combination of sensor and evaluation/simulation unit in a condition monitoring system.

The evaluation unit or the simulation unit, as appropriate, has for example a screen display whereby, in particular, a result value is shown on the display screen. Outputs in the form of a graphic or a value, by means of a printer, an acoustic and/or visual message, a traffic light indication, or the like, are also possible. Furthermore, a bearing state value can also be shown. In a development of the screen display, it has a pointer (digital or mechanical), by means of which a value can be represented. In one embodiment of the display, if the displayed value exceeds a threshold a warning can be shown.

In one embodiment of the method, the measured values are processed in real time in the simulation unit and/or in the evaluation unit. In this case, result values and/or bearing state values can be shown to a person, that is to an operator, in real time. Real time means that the processing or the display, as applicable, takes place almost immediately. A time delay can arise due, for example, to computing times or data transmission times.

In one embodiment of the method, result values or values which depend on result values are stored together with a state value for a converter. State values for a converter which supplies the electric machine (the electric motor), the bearing of which is being monitored, are for example:

intermediate circuit voltage,

maximum current,

maximum voltage,

present power,

pulse pattern,

pulse frequency,

point in time of the pulse pattern switchover,

etc.

For the purpose of carrying out the method, it is possible to use various systems for determining a bearing state of a bearing in an electric machine.

One such system for determining a bearing state of a bearing in an electric machine has, for example, a simulation unit, a sensor unit and/or an evaluation unit, where the simulation unit is provided for processing data from the sensor unit and where the evaluation unit is provided for processing data from the simulation unit.

In one embodiment of the system, the simulation unit has a model for simulating the bearing. The model can, for example, be used for calculating a crater-producing energy for the bearing under consideration.

In one embodiment of the system, the simulation unit has a simulation model for calculating the lubrication gap, bearing capacitance and/or bearing current from the machine parameters and the external measured values. Machine parameters are, for example, the geometric dimensions of the motor, slots, insulators, lengths, numbers of slots etc. From these, stray capacitances of the motor are calculated and the simulation model constructed. In doing this, a capacitive equivalent circuit diagram for the motor can be used as part of the model.

A precise state specification for the bearing or bearings, as applicable, from the simulation model can also provide a statement as to the wear states of the motor bearing and/or the bearing grease. Using the estimate of a remaining service time, an end user can plan the maintenance intervals more exactly, and thus prevent unplanned outages.

The discharge time-constant and energy of the discharge depend on the thickness of the lubricating film in the bearing. As a preliminary it is possible, for example, to record a characteristic curve showing what lubricating film thickness results in what time constant and electrical capacitance. Together with a BVR (bearing voltage ratio) and the common mode voltage of the converter it is possible from this to draw conclusions about the crater-producing energy. It is also possible to use parameters derived from the time constant and the energy, e.g. the energy per unit volume at a particular voltage.

A method for determining the lubricating film thickness via the charging time-constant can also be used in a bearing test rig. On this test rig, the lubricating film thicknesses are determined as a function of the rotational speed, bearing load and temperature. The result is a family of characteristic curves which is integrated into the simulation model. On the basis of the external measured values, it is now possible to draw conclusions about the lubricating film thickness. In this way, 3D characteristic curves can be determined as a preliminary on a test rig. It is also possible to apply the method described in relation to the test rig to online measurement.

In the case of the dynamic process of bearing current development, the energy of the arc discharge can be particularly damaging if the discharge takes place over a short period of time, so that the energy is sufficient to vaporize metal or even to spray it off as a plasma before the energy flows away at the speed of sound by thermal conduction. Typical times within which crater-producing energy is released before the energy has been dissipated lie in the range from 100 ps up to 1 ns.

Characteristic curves for the time constants, for example, can be calculated analytically or simulated numerically, and for the discharge times can be measured as a function of the lubricating film thickness. The characteristic curves then form a “bridge” between the mechanical parameter “lubricating film thickness” and the material erosion due to vaporization, which leads to ripple formation. It is then possible to estimate, by reference to a combination of the electrical, thermo-dynamic and mechanical models, the effects of vibrations which are evoked during normal operation or due to prior damage (nicks in transport or assembly).

If measured values relating to the bearing are now used as input variables for a computational model, this makes it possible to determine variables which are really relevant, even if unknown to a user.

Motor and system data for the modeling can be fed to a measurement device (with a sensor) by a simple input system. Connected to a computational unit (this is for example the simulation unit and/or the evaluation unit) is an appropriate measurement unit (in particular the measurement device), which determines relevant external data (e.g. conductor-ground voltage, shaft voltage, bearing variables in operation). A combination with the bearing current sensor is also possible.

There can be more than one sensor unit. For example, one unit for each bearing assembly. A third unit for the measurement of the terminal voltages and the ground variables, etc. In one form of embodiment, an evaluation unit is fed to each sensor unit. However, the linkage of two evaluation units is also possible. For example, it is possible to deduce whether a particular bearing current represents circulating currents, by combining at least two units (bearing 1 current positive peak, bearing 2 current negative peak=>circulating current).

From the data obtained from the simulation unit and/or the evaluation unit) it is also possible, from the wear state of a bearing and the bearing grease, to deduce (conclude) RCM statements and measures. Here, RCM stands for Reliability Centered Maintenance (measures for reliability oriented servicing/upkeep). This is to be understood as including, for example, the following:

a shortening of the lubrication intervals,

a shortening of the grease change intervals,

a shortening of the bearing replacement intervals,

etc.

The simulation model, which runs for example on a measurement device process computer, can be based on a motor model which, for example, can be run on one of the common motor simulation platforms. By means of an electrical model of this sort, it is possible to describe the high-frequency behavior of motors. The HF models are supplemented by mechanical bearing models.

In the configuration phase of a system, it is possible, by embedding these models in a system simulation which takes into consideration the properties of the power feed, converter and grounding system, to make statements about critical bearing loadings which might possibly occur. Possible remedies can thus be tested out even at the simulation stage. The simulation values from the system configuration phase can now, embedded in appropriate process parameters, serve as reference values for the identical, or almost identical, simulation model of the CM system (condition monitoring system). Possible differences between real operation and simulation values can thus be detected, and selectively forwarded for analysis. Possible remedial measures can in this way be more rapidly and more efficiently carried out.

Until now in real systems, changes have been made aimlessly at many points, in the hope that the correct modification would also be implemented. This is very expensive. By the prior use of the simulation, the work can be restricted to precisely that work which would lead to elimination of the problem. In practice, this brings both time and cost advantages.

Measurements are used to determine vibrations and, if appropriate, also the temperature and other measured values such as the state of the lubricating grease. The measured values are input into a mechanical model. The temperature can also be known, where any measurement of the temperature is preferably made close to the bearing. The thickness of the lubricating film is connected with the temperature. If no temperature is measured, it must be estimated or even defined. An estimate can be made, for example, from the temperature of the motor (winding). The thickness of the lubricating film is determined by reference to the mechanical model. Advantageously, this will be done in the frequency domain or in the time domain, i.e. dynamically.

One simple way of considering the matter is to assume a constant lubricating gap can be used. Using the lubricating film thickness and other data such as the bearing voltage, or indirect values from which the bearing voltage or a comparable parameter can be deduced, the crater-producing energy, or a comparable parameter which takes into account the heat dissipation over time (thermodynamic view), is determined by reference to characteristic lines or a model.

Using the data about the bearing (e.g. geometric data and material data) and a model of the material erosion (e.g. ripple volume, sublimation energy, vaporization energy and/or fusion energy per unit volume), it is possible to determine an expected service life for the bearing. A comparison with the requirements will show if changes are necessary. These can then be evaluated, if necessary, in a new run through of the schema. Depending on the required changes, it may be necessary to carry out a complete run through, or only a partial run through may be needed.

Various elements of the schema can be combined by more complex modeling, e.g. using a model which incorporates at the same time the crater-producing energy and the material erosion. It is advantageous if measurements are combined, by means of the model or the characteristic curves, as applicable, with the simulations and a thermodynamic view, in particular the heat dissipation.

With one embodiment of the method, after a determination of the bearing state a mechanical change is made to the bearing and/or the electric machine. The term determination of the bearing state is to be understood, for example, as follows:

determination, estimation and/or calculation of a bearing current;

determination, estimation and/or calculation of the wear for the bearing;

determination, estimation and/or calculation of a remaining service life for the bearing;

etc.

The term mechanical change to the bearing and/or the electric machine is to be understood, for example, as follows:

a measure to insulate the bearing;

installation of a grounding brush;

installation of a symmetrically screened motor connection cable;

installation of a screening contact through a 360° connection;

HF grounding of one or more components, such as for example on the electric machine, the bearing and/or the converter;

meshed interconnection of the system grounding;

the establishment equipotential bonding in the system; and/or

the use of a common mode filter.

With one form of embodiment of the method, after the bearing state has been determined a mechanical change is made to the bearing and/or to the electric machine, after which another determination of the bearing state is carried out.

A system can be designed in such a way that the model or models, as applicable, is/are executed on an integrated process computer. The process computer could, for example, be a programmable logic controller or even a system management computer.

In the case of the system for monitoring the bearing, the evaluation unit used can be provided for the determination of at least one of the following values, as applicable:

a bearing current;

the energy transferred through a bearing lubrication gap;

the energy density transferred through a bearing lubrication gap;

a value for the bearing service life and/or remaining service life;

a value for a wear state of the bearing; or

a value for a wear state of the bearing grease.

In one embodiment of the system, it has a converter where the converter has a data link with at least one of the following units, as appropriate:

with the simulation unit;

with the sensor unit;

with the evaluation unit; or

with a combination of these units.

Using this data link, such data as voltage, current, pulse pattern, energy, active power, reactive power, intermediate circuit voltage, frequency can be communicated to the relevant unit, for this data to be processed there.

Further possible features, advantages and details of the invention are to be seen, by way of example, from the following description of variant embodiments, making reference to the drawings. These show, for example:

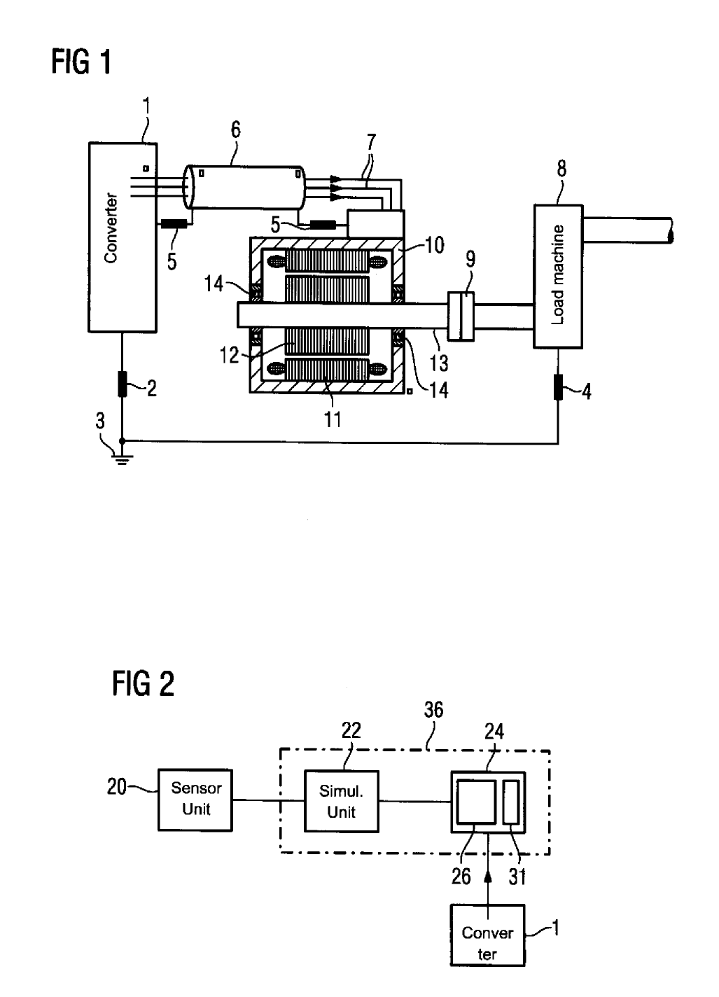

FIG. 1 a diagram of the principle of one design of a dynamo-electric machine with surrounding system components;

FIG. 2 a system for the determination of a bearing state for a bearing in an electric machine;

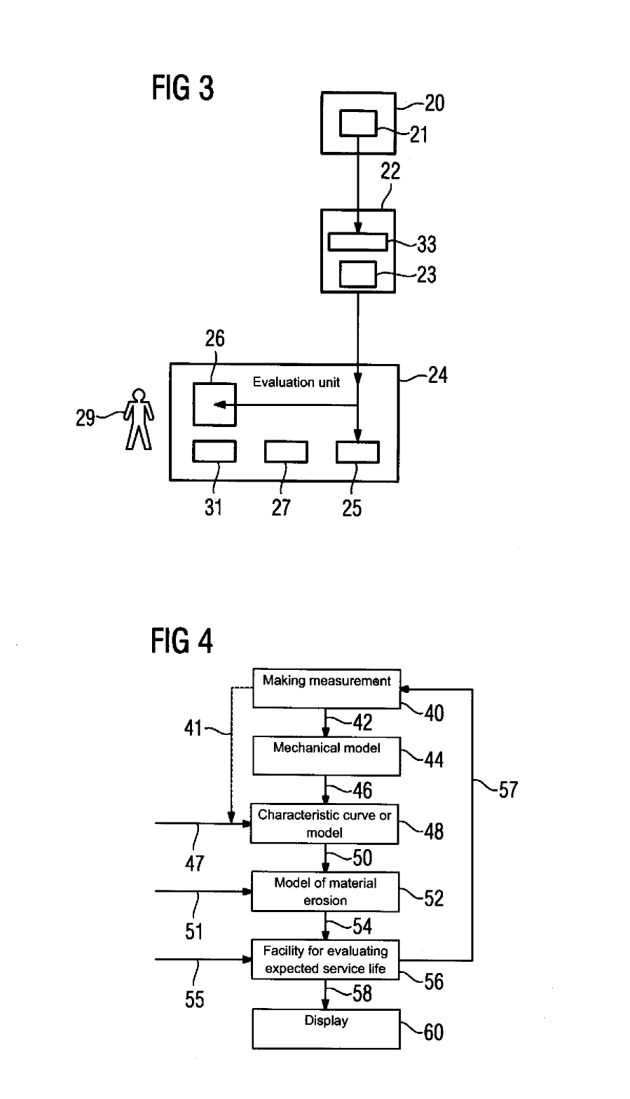

FIG. 3 a method for the determination of a bearing state for a bearing in an electric machine; and

FIG. 4 a method for checking the life of a bearing.

Parts which correspond to one another have been given the same reference marks in the figures.

FIG. 1 shows in outline a diagram of the principle of one design of a dynamo-electric machine with its surrounding system components. In detail, a converter 1 is here connected via connecting cables 7 to a dynamo-electric machine which is located within a motor housing 10 and has a stator 11, and a rotor 12 which drives or is driven by a load machine 8, via a bearing 14 and a shaft 13 through a coupling 9.

The electrical connection between the converter 1 and the dynamo-electric machine through the connecting cable 7 has a cable screen 6, which is given an appropriate bonding 5 to the ground of the converter or motor housing, as applicable. Both the converter 1 and also the load machine 8 are bonded to ground 3 via a ground connection 2 or 4 respectively. The motor can also be bonded to ground, although this is not shown in the figure. There can be, for example, two grounding points on the motor. One grounding point lies, for example, in the region of a frame foot on the motor. Another grounding point lies, for example, in the region of a terminal box of the motor. The converter 1, in particular in the form of a voltage source converter, presents its output voltage by controlled connection of the d.c. intermediate circuit to the output. In a two-level power inverter, a change between positive and negative potential in rapid succession leads to a voltage waveform, for which the sum of the three-phase voltage is not equal to zero, and produces the so-called common mode voltage. Each of these steep voltage switching operations causes high-frequency excitations, with currents which result from them which flow back to the source along parasitic paths.

The illustration in FIG. 2 shows a system which has:

a sensor unit 20;

a simulation unit 22;

an evaluation unit 24; and

a converter 1.

The sensor unit 20 has a data link to the simulation unit 22. The simulation unit 22 has a data link to the evaluation unit 24. The converter 1 has a data link to the evaluation unit 24. The evaluation unit 24 has a display screen 26. State values 31 can be transmitted from the converter 1 to the evaluation unit 24 and can be stored there. The functions of the simulation unit 22 and the evaluation unit 24 can be realized using software and/or hardware.

In one embodiment, the simulation unit 22 and the evaluation unit are integrated into a process computer 36. The schematic structure of a system for assessing a bearing, shown in FIG. 2, shows that a real time assessment of the bearing state can be achieved.

The diagram in FIG. 3 shows a method by which bearing state data can be determined. Using a sensor unit 20, a measured value 21 is determined. The measured value 21 is transmitted to the simulation unit 22. The simulation unit 22 has a model 33. Using the model 33, which can also be a characteristic curve, and the measured value 21, a result value 23 is determined. This result value 23 is communicated to the evaluation unit 24. The evaluation unit 24 has a screen display 26, which can be read off by a person 29. Using result values 25, 27, at least one state value 31 is determined for the bearing under observation.

The diagram shown in FIG. 4 shows a method for checking the service life of a bearing. First, a measurement 40 is made. This relates, in particular, to vibration values and/or temperature values. The values are transmitted over a data path 42 into a mechanical model 44. Using this mechanical model 44 it is possible, for example, to determine a thickness for the lubricating film, its graph against time and/or a corresponding amplitude frequency response. These values (e.g. lubricating film thickness) are communicated onward via a data path 46, in order to feed them into a characteristic curve 48 or a model 48, as applicable, for the determination of a crater producing energy. This intermediate model 48 (characteristic curve or model for the determination of a crater producing energy, as applicable) is not only fed with values 46 from the mechanical model 44, but also by further values 47. These are, for example:

temperature;

BVR (bearing voltage ratio);

intermediate circuit voltage in a converter 1;

common mode voltage;

bearing voltage;

etc.

Over and above this, measured values from the measurement 40 can be processed in the model 48, via a data path 41.

Result values, such as for example the crater producing energy, which can be determined using a characteristic curve or from the model 48, as applicable, reach a model of material erosion 52 via a data path 50. Data about the bearing is fed into the model of material erosion 52 via a data path 51. From this is given a value in relation to the forecast service life of the bearing. This value for the forecast bearing service life is communicated via a data path 54 to a facility 56 for evaluating the expected service life. This facility 56 is supplied with data relating to the requirements in respect of the service life of the bearing via a data path 55.

If, for example, the assessment of the expected service life is too low, a design change can be requested, for example, after which a measurement 40 is again requested. This is indicated by the path 57. If the assessment of the expected service life is regarded as being acceptable, this information can be output, for example graphically on a display 60, via a data path 58.

What is claimed is:

1.-12. (canceled)

13. A method for determining a bearing state for a bearing in an electric machine, comprising the steps of:
determining with a sensor unit a measured value,
transmitting the measured value to a simulation unit,
determining with the simulation unit a result value selected from a bearing current value or a value which depends on the bearing current, and
transmitting the result value to an additional unit.

14. The method of claim 13, and further comprising the step of displaying the result value on a screen display of the additional unit.

15. The method of claim 13, wherein the additional unit is an evaluation unit, said evaluation unit processing the result value so as to determine a bearing state value.

16. The method of claims 15, and further comprising the steps of processing the measured values in the, simulation unit or in the evaluation unit in real time, and displaying the result value or bearing state value, or both, in real time to a user.

17. The method of claim 13, and further comprising the step of storing the result value or a value that depends on the result value together with a state value of a converter connected to the electric machine.

18. The method of claim 13, and further comprising the steps of making a mechanical change to the bearing or to the electric machine, or both, after determining the bearing state, and once more determining the bearing state after the mechanical change has been made.

19. A system for determining a bearing state for a bearing in an electric machine, comprising:
sensor unit,
a simulation unit configured for processing data from the sensor unit, and
an evaluation unit configured for processing data from the simulation unit.

20. The system of claim 19, wherein the simulation unit comprises a model for calculating an energy producing craters in the bearing.

21. The system of claim 20, wherein the model is executed on an integrated process computer.

22. The system of claim 19, wherein the evaluation unit is configured to determine at least one of the following values:
a bearing current,
energy transferred through a bearing lubrication gap,
energy density transferred through the bearing lubrication gap,
a value for at least one of the bearing service life and a remaining bearing service life,
a value for the wear state of the bearing, and
a value for the wear state of the bearing grease.

23. The system of claim 19, further comprising a converter, with the converter having a data link to at least one of the following units:
the simulation unit;
the sensor unit; and
the evaluation unit.
